(19) United States
(12) Patent Application Publication
(10) Pub. No.: US 2023/0177380 A1
(43) Pub. Date: Jun. 8, 2023

(54) LOG ANOMALY DETECTION

(71) Applicant: International Business Machines Corporation, Armonk, NY (US)

(72) Inventors: Sahil Bansal, Kurukshetra (IN); Harshit Kumar, Delhi (IN); Lu An, Raleigh, NC (US); Xiaotong LIU, San Jose, CA (US); ANBANG XU, San Jose, CA (US)

(21) Appl. No.: 17/457,924

(22) Filed: Dec. 7, 2021

(51) Int. Cl. G06N 20/00

(52) U.S. Cl. CPC G06N 20/00

(57) ABSTRACT

One or more computer processors classify each log line in a plurality of unlabeled log lines as an erroneous log line or a non-erroneous log line; templatize each classified erroneous log line and non-erroneous log line in the plurality of unlabeled log lines; cluster erroneous log templates into erroneous log template clusters and non-erroneous log templates into non-erroneous log template clusters; identify one or more log lines as anomalous utilizing a plurality of factors including a log maturity, a number of encountered log template clusters, and a ratio of classified erroneous log lines to classified non-erroneous log lines; responsive to one or more identified anomalous log lines, validate the identified anomalous log lines utilizing a site reliability engineer and human-in-the-loop validation; train a log anomaly model utilizing one or more validated log lines; and identify a subsequent log line as anomalous utilizing the trained log anomaly model.

The following disclosure(s) are submitted under 35 U.S.C. 102(b)(1)(A):

IBM Canada Software Announcement: IBM Cloud Pak for Watson AIOps 3.1 helps SREs and IT teams to maintain a high availability of applications and helps remediate and resolve incidents through automation; Sahil Bansal, Harshit Kumar, Lu An, Xiaotong Liu, and Anbang Xu; Mar. 18, 2021.

### BACKGROUND

The present invention relates generally to the field of machine learning, and more particularly to anomaly detection.

Machine learning (ML) is the scientific study of algorithms and statistical models that computer systems use to perform a specific task without using explicit instructions, relying on patterns and inference instead. Machine learning is seen as a subset of artificial intelligence. Machine learning algorithms build a mathematical model based on sample data, known as training data, in order to make predictions or decisions without being explicitly programmed to perform the task. Machine learning algorithms are used in a wide variety of applications, such as email filtering and computer vision, where it is difficult or infeasible to develop a conventional algorithm for effectively performing the task.

Anomaly detection is the identification of rare items, events or observations which raise suspicions by differing significantly from the majority of the data. Typically, the anomalous items will translate to some kind of problem such as bank fraud, a structural defect, medical problems or errors in a text. Anomalies are also referred to as outliers, novelties, noise, deviations, and exceptions.

### SUMMARY

Embodiments of the present invention disclose a computer-implemented method, a computer program product, and a system. The computer-implemented method includes one or more computer processers classifying each log line in a plurality of unlabeled log lines as an erroneous log line or a non-erroneous log line utilizing a dictionary based classifier within a hybrid error classifier. The one or more computer processors templatize each classified erroneous log line and non-erroneous log line in the plurality of unlabeled log lines. The one or more computer processors cluster erroneous log templates into erroneous log template clusters and non-erroneous log templates into non-erroneous log template clusters. The one or more computer processors identify one or more log lines as anomalous utilizing a plurality of factors including a log maturity, a number of encountered log template clusters, and a ratio of classified erroneous log lines to classified non-erroneous log lines. The one or more computer processors, responsive to one or more identified anomalous log lines, validate the identified anomalous log lines utilizing a site reliability engineer and human-in-the-loop validation. The one or more computer processors train a log anomaly model within the hybrid error classifier utilizing one or more validated log lines. The one or more computer processors identify a subsequent log line as anomalous utilizing the trained log anomaly model.

### BRIEF DESCRIPTION OF THE DRAWINGS

Figure (i.e., FIG. 1 is a functional block diagram illustrating a computational environment, in accordance with an embodiment of the present invention;

FIG. 2 is a flowchart depicting operational steps of a program, on a server computer within the computational environment of FIG. 1, for evolutionary log anomaly detection, in accordance with an embodiment of the present invention; and

FIG. 3 is a block diagram of components of the server computer, in accordance with an embodiment of the present invention.

### DETAILED DESCRIPTION

Artificial intelligence in information technology operations (AIOps) has an essential role in modern, data driven organizations and operations. AIOps utilize big data to aggregate siloed information technology operations data allowing efficient digital transformation (e.g., multiple environments, virtualized resources, dynamic infrastructure), cloud migration, and developmental operations (e.g., provisioning and reconfiguring infrastructure). Anomaly pipelines play an important role within AIOps, where anomaly pipelines detect data anomalies within an AIOps data pipeline. Anomaly pipelines monitor integrated systems and components within an AIOps system, collect information associated with detected anomalies, and utilize the collected information to mitigate the anomaly, such as fault localization supporting root cause analysis. Anomaly pipelines underpin many AIOps systems, thus highly accurate anomaly detection is a requirement for efficient and effective AIOps. For example, false positives in anomaly detection streams errors to the rest of the pipeline causing a reduction in operational efficiency and increased computational wastage. Currently, modern anomaly pipelines require substantial amounts (e.g., thousands of labelled log lines) of log data (i.e., training data) corresponding to a healthy state of monitored system, data pipeline, or component. These modern anomaly pipelines are particularly inefficient and ineffective in “0-day” scenarios occurring as the pipeline is initially deployed and training data is scarce. Obtaining the required training data can be prohibitively expensive for many organizations due to the state of monitored system (e.g., mixture of healthy and unhealthy logs, log velocity, computational constraints, etc.). Anomaly pipelines trained with ineffective training data produce increased levels of false positives. There is an increasing need for an anomaly detection system that efficiently detects point-in-time anomalies in initial deployment situations (i.e., “0-day”).

Embodiments of the present invention provide a system to detect point-in-time anomalies in initial deployment situations with a reduction in anomalous false positives. Embodiments of the present invention reduce false positives by bootstrapping an internal dictionary from associated documentation while incrementally training a machine learning detector. Embodiments of the present invention improve newly deployed log anomaly detection systems through incremental system updates using clustering of templatized log lines to identify anomalous log lines. Embodiments of the present invention reduce the required amount of training data (i.e., logs) for effective anomaly detection. Embodiments of the present invention correlate anomalous events with other event data across environments to identify the cause of an outage or performance problem and suggest or implement remedies. Implementation of embodiments of the invention may take a variety of forms, and exemplary implementation details are discussed subsequently with reference to the Figures.

The present invention will now be described in detail with reference to the Figures.

FIG. 1 is a functional block diagram illustrating a computational environment, generally designated 100, in accordance with one embodiment of the present invention. The term “computational” as used in this specification describes a computer system that includes multiple, physically, distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computational environment 100 includes server computer 120 connected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between server computer 120, and other computing devices (not shown) within computational environment 100. In various embodiments, network 102 operates locally via wired, wireless, or optical connections and can be any combination of connections and protocols (e.g., personal area network (PAN), near field communication (NFC), laser, infrared, ultrasonic, etc.).

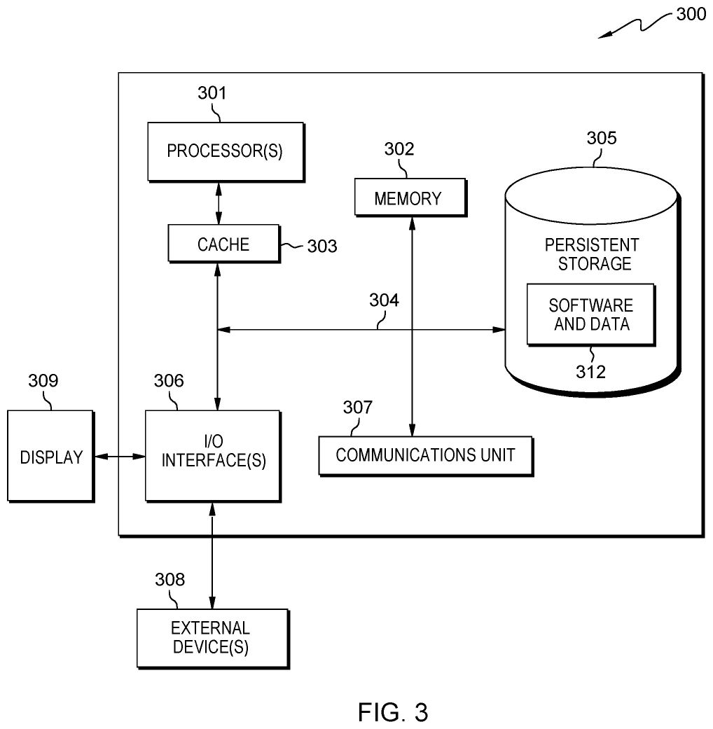

Server computer 120 can be a standalone computing device, a management server, a web server, a mobile computing device, or any other electronic device or computing system capable of receiving, sending, and processing data. In other embodiments, server computer 120 can represent a server computing system utilizing multiple computers as a server system, such as in a cloud computing environment. In another embodiment, server computer 120 can be a laptop computer, a tablet computer, a netbook computer, a personal computer (PC), a desktop computer, a personal digital assistant (PDA), a smart phone, or any programmable electronic device capable of communicating with other computing devices (not shown) within computational environment 100 via network 102. In another embodiment, server computer 120 represents a computing system utilizing clustered computers and components (e.g., database server computers, application server computers, etc.) that act as a single pool of seamless resources when accessed within computational environment 100. In the depicted embodiment, server computer 120 includes log 122 and program 150. In other embodiments, server computer 120 may contain other applications, databases, programs, etc. which have not been depicted in computational environment 100. Server computer 120 may include internal and external hardware components, as depicted and described in further detail with respect to FIG. 3.

Log 122 is a repository for data used by program 150. In the depicted embodiment, log 122 resides on server computer 120. In another embodiment, log 122 may reside elsewhere within computational environment 100 provided program 150 has access to log 122. A database is an organized collection of data. Log 122 can be implemented with any type of storage device capable of storing data and configuration files that can be accessed and utilized by program 150, such as a database server, a hard disk drive, or a flash memory. In an embodiment, log 122 contains a plurality of log line 124. Log line 124 is an unlabeled data point derived from historical performance and event data, streaming real-time operations events, system logs and metrics, network data (i.e., packet data), incident-related data and ticketing, and related document-based data. In an embodiment, log line (LL) 124 contains an event in a series of events that occurred in a monitored system or component, where each event is associated with a timestamp and a description describing the nature of the event. In a further embodiment, each event includes severity level, thread ID, ID of the originating component, host name, etc.

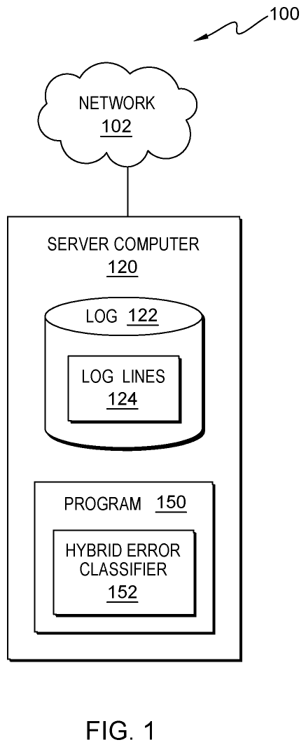

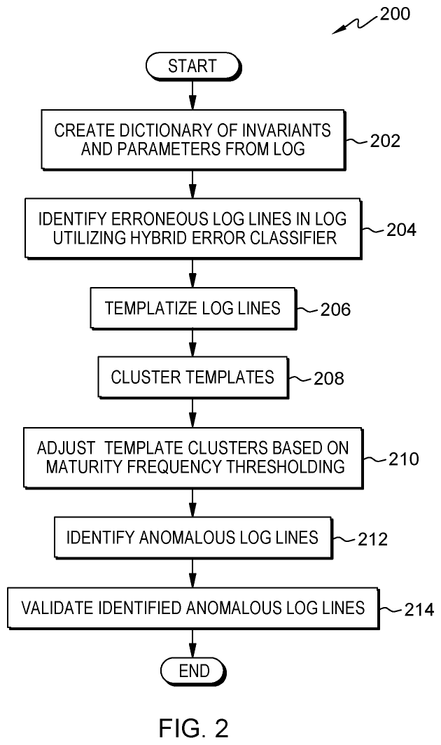

Program 150 is a program for evolutionary log anomaly detection. In various embodiments, program 150 may implement the following steps: classify each log line in a plurality of unlabeled log lines as an erroneous log line or a non-erroneous log line utilizing a dictionary based classifier within a hybrid error classifier; templatize each classified erroneous log line and non-erroneous log line in the plurality of unlabeled log lines; cluster erroneous log templates into erroneous log template clusters and non-erroneous log templates into non-erroneous log template clusters; identify one or more log lines as anomalous utilizing a plurality of factors including a log maturity, a number of encountered log template clusters, and a ratio of classified erroneous log lines to classified non-erroneous log lines; responsive to one or more identified anomalous log lines, validate the identified anomalous log lines utilizing a site reliability engineer and human-in-the-loop validation; train a log anomaly model within the hybrid error classifier utilizing one or more validated log lines; and identify a subsequent log line as anomalous utilizing the trained log anomaly model. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over network 102. In various embodiments, client versions of program 150 resides on any other computing device (not depicted) within computational environment 100. In the depicted embodiment, program 150 includes hybrid error classifier 152. Program 150 is depicted and described in further detail with respect to FIG. 2.

Hybrid error classifier 152 is representative of a dual classifier/model for determining whether a log line 124 is an erroneous log line (ELL) or a non-erroneous log line (NELL). In an embodiment, hybrid error classifier 152 initially utilizes a dictionary or list (i.e., classifier component) of symptom-words to identify the erroneous log lines. In this embodiment, program 150 bootstraps the dictionary utilizing a product and software documentation. In another embodiment, hybrid error classifier 152 is a NOI classifier that classifies each log line to one of the following categories: “Information”, “Unknown”, “Latency”, “Saturation”, “Exception”, “State Change”, etc. In another embodiment, as program 150 matures and continues to see novel logs, hybrid error classifier 152, responsively, utilizes learning techniques to train (i.e., model component), calculate weights, ingest inputs, and output a classification. In an embodiment, hybrid error classifier 152 is comprised of any combination of deep learning model, technique, and algorithm (e.g., decision trees, Naive Bayes classification, support vector machines for classification problems, random forest for classification and regression, linear regression, least squares regression, logistic regression). In an embodiment, hybrid error classifier 152 utilizes transferrable neural networks algorithms and models (e.g., long short-term memory (LSTM), deep stacking network (DSN), deep belief network (DBN), convolutional neural networks (CNN), compound hierarchical deep models, etc.) that can be trained with supervised or unsupervised methods. The training of error classifier 152 is depicted and described in further detail with respect to FIG. 2.

The present invention may contain various accessible data sources, such as log 122, that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Program 150 provides informed consent, with notice of the collection of personal data, allowing the user to opt in or opt out of processing personal data. Consent can take several forms. Opt-in consent can impose on the user to take an affirmative action before the personal data is processed. Alternatively, opt-out consent can impose on the user to take an affirmative action to prevent the processing of personal data before the data is processed. Program 150 enables the authorized and secure processing of user information, such as tracking information, as well as personal data, such as personally identifying information or sensitive personal information. Program 150 provides information regarding the personal data and the nature (e.g., type, scope, purpose, duration, etc.) of the processing. Program 150 provides the user with copies of stored personal data. Program 150 allows the correction or completion of incorrect or incomplete personal data. Program 150 allows the immediate deletion of personal data.

FIG. 2 depicts flowchart 200 illustrating operational steps of program 150 for evolutionary log anomaly detection, in accordance with an embodiment of the present invention.

Program 150 creates a dictionary of invariants and parameters from a log (step 202). In an embodiment, program 150 initiates responsive to a collection of unlabeled data (e.g., log data). In an embodiment, program 150 bootstraps the dictionary of invariants and parameters from product and software documentation, either provided by developers or available in the public domain. In this embodiment, documentation includes standard textual documents such as user manuals, incident descriptions or specialized lists of product offerings. In a further embodiment, program 150 extracts invariants and parameters from documentation utilizing entity extraction. For example, the incident descriptions provide error codes while, specialized lists of product offerings are utilized to populate the dictionary. In an embodiment, program 150 extracts a list of invariants and parameters based on the frequency distribution of an initial set of logs. In another embodiment, program 150 preserves identified invariants while replacing identified parameters with <P> tokens. In an embodiment, program 150 utilizes the bootstrapped dictionary for log line templatization as described in step 206.

Program 150 identifies erroneous log items utilizing a hybrid error classifier (step 204). Program 150 analyzes log 122 by iteratively identifying log lines as erroneous or non-erroneous utilizing hybrid error classifier 152. In an embodiment, hybrid error classifier 152 utilizes a dictionary or list of symptom-words to identify erroneous log lines. Program 150 aggregates each identified erroneous and non-erroneous log line into erroneous or non-erroneous log line clusters or log files (e.g., a log cluster containing only erroneous log lines).

Program 150 templatizes the log from the created dictionary (step 206). Program 150 respectively templatizes the identified erroneous and non-erroneous log lines through invariant and parameter log line identification and tokenization. In an embodiment, program 150 templatizes each identified erroneous and non-erroneous log line utilizing a dictionary of bootstrapped invariants and parameters over a temporal period converging onto template subsets representing the entirety of the identified log lines. In another embodiment, program 150 utilizes a template miner, such as AQL-rules, to create a plurality of log templates from the identified erroneous and non-erroneous log lines. In an embodiment, program 150 utilizes the template miner to extract patterns from log 122 with the following steps: cleaning log lines; checking for matching log templates using a fixed depth tree; responsive to one or more matched log templates, identifying a similar log within the one or more matched log templates; and responsive to no matched log templates, creating a new log template.

Program 150 clusters templatized log lines (step 208). Program 150 clusters each log template or templatized log lines into one or more erroneous log template clusters (ELTCs) or non-erroneous log template clusters (non-ELTC). In an embodiment, program 150 utilizes fuzzy clustering techniques to cluster the log templates. In this embodiment, program 150 computes a lexical similarity between a log template and an existing log template cluster, where the lexical similarity is calculated from an aggregated value of all templates within the existing log template cluster. In another embodiment, program 150 utilizes curriculum clustering to cluster the templates. In yet another embodiment, program 150 utilizes hierarchical clustering without embedding. In this embodiment, program 150 first extracts entity, action and symptom words from log templates; then program 150 prepares a sequence of words for the log templates using the extracted words while preserving word order; lastly program 150 computes a jaro distance between sentences while using the jaro distance to perform the hierarchical clustering. In an embodiment, program 150 checks if a template is substantially similar (e.g., exceeds a jaro distance threshold or lexical similarity) to any of the existing template clusters. Responsive to a similar template, program 150 updates the frequency distribution and counts of the template and associated template clusters, thus keeping the existing template clusters updated.

Program 150 adjusts template clusters based on maturity frequency thresholding (step 210). Responsive to one or more templates clusters, program 150 calculates a frequency distribution comprising the distributions for each template cluster. In an embodiment, program 150 removes highly frequent (e.g., template clusters containing more than 40% of the templates, exceed frequency threshold, etc.) template clusters while maintaining the remaining template clusters. Responsive to the cluster reduction, program 150 calculates another frequency distribution with the remaining template clusters. With this frequency distribution, program 150 computes a frequency threshold for the template clusters, where the frequency threshold is an exponentially increasing function that is updated based on the maturity (i.e., as the system ages, the threshold is increased) of a monitored system or component. In an embodiment, program 150 initially sets the frequency threshold to the median, but any point between the first and third quartile of the frequency distribution is suitable. In this embodiment, program 150 sets the rate of increase for the frequency threshold based on dataset considerations, precision or recall system requirements.

Program 150 identifies log anomalies (step 212). In an embodiment, program 150 identifies any log template cluster (non-erroneous or erroneous), and all included log lines, with a frequency count less than the frequency threshold (e.g., median or third quartile) as anomalous. In another embodiment, responsive to a plurality of factors such as maturity level (e.g., log quantity, etc.), number of encountered template clusters by the system, and ratio of erroneous log lines compared to non-erroneous log lines, program 150 identifies said logs and clusters as anomalous. For example, at an early stage (e.g., a week of unlabeled collected logs, low ratio (e.g., 4 to 1) of non-erroneous to erroneous, and few (e.g., less than 4) encountered template clusters, etc.) and responsive to a plurality of identified non-erroneous logs or templates program 150 labels each log or template cluster as non-anomalous or healthy.

Responsive to a subsequent log line (e.g., novel log line or log line absent from initial logs (i.e., training data)) matching into an anomalous erroneous or non-erroneous template cluster, program 150 identifies the subsequent log line as anomalous. Responsive to the subsequent log line (i.e., erroneous log line) absent (i.e., failing to exceed a lexical similarity threshold) from the erroneous log template clusters, program 150 identifies the subsequent log line as an anomaly, templatizes the subsequent log line, creates a new erroneous log template cluster with the templatized subsequent log line, and sets the frequency count of the new erroneous log template cluster to one. Any future occurrence of similar log lines (i.e., within the new erroneous log template cluster) are classified as anomalous until a frequency threshold (e.g., third quartile) is reached or exceeded. Responsive to the subsequent log line (i.e., non-erroneous log line) absent from the non-erroneous log template clusters, program 150 identifies the subsequent log line as a non-anomaly, templatizes the subsequent log line, creates a new non-erroneous log template cluster with the templatized subsequent log line, and sets the frequency count of the new non-erroneous log template cluster to one. Any future occurrence of similar log lines (i.e., within the new non-erroneous log template cluster) are classified as non-anomalous until a frequency threshold (e.g., first quartile) and a timestamp threshold (i.e., abs[log line timestamp—threshold]) are reached or exceeded. In an embodiment, program 150 correlates anomalous events (i.e., log lines) with other events across environments (e.g., system, logs, versions, locations, etc.) to identify the cause of the anomalous event (e.g., outage, performance variation, or computational disparity) and suggest or implement remedies. For example, program 150 adjusts computational resources to a monitored system continuing to output anomalous log lines. In this embodiment, program 150 presents suggestions or remedies to a user.

Program 150 validates identified log anomalies (step 214). Responsive to one or more identified anomalous log lines or anomalous template clusters, program 150 validates said anomalies. In an embodiment, program 150 involves human-in-the-loop techniques for validation and utilizes returned anomaly validation for semi-supervised training of hybrid error classifier 152. For example, program 150 incorporates suggestions and observations (i.e., validation) from a site reliability engineer (SRE) as program 150 presents the SRE with the identified anomalies. This embodiment reduces the percentage of false anomalies in earlier stages of an anomaly detection pipeline. In an embodiment, SRE validation is triggered responsive to an incorrect prediction, identification, or cluster from one or more component classifiers and models within hybrid error classifier 152. In a further embodiment, program 150 automatically corrects non-anomalous, anomalous log lines, and template clusters identified as incorrect by SRE validation. In this embodiment, program 150 responsively adjusts template clusters and reclassifies comprising log lines according to SRE recommendations. In another embodiment, program 150 incrementally updates hybrid error classifier 152 by training a component model (e.g., neural network as opposed to the initially utilized dictionary based component) with the frequency threshold reduced log template clusters to identify anomalous non-erroneous lines, anomalous non-erroneous clusters, anomalous erroneous log lines, and anomalous erroneous log clusters within subsequent log lines.

FIG. 3 depicts block diagram 300 illustrating components of server computer 120 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Server computer 120 each include communications fabric 304, which provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications, and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of computer processor(s) 301 by holding recently accessed data, and data near accessed data, from memory 302.

Program 150 may be stored in persistent storage 305 and in memory 302 for execution by one or more of the respective computer processor(s) 301 via cache 303. In an embodiment, persistent storage 305 includes a magnetic hard disk drive. Alternatively, or in addition to a magnetic hard disk drive, persistent storage 305 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305. Software and data 312 can be stored in persistent storage 305 for access and/or execution by one or more of the respective processors 301 via cache 303.

Communications unit 307, in these examples, provides for communications with other data processing systems or devices. In these examples, communications unit 307 includes one or more network interface cards. Communications unit 307 may provide communications through the use of either or both physical and wireless communications links. Program 150 may be downloaded to persistent storage 305 through communications unit 307.

I/O interface(s) 306 allows for input and output of data with other devices that may be connected to server computer 120. For example, I/O interface(s) 306 may provide a connection to external device(s) 308, such as a keyboard, a keypad, a touch screen, and/or some other suitable input device. External devices 308 can also include portable computer readable storage media such as, for example, thumb drives, portable optical or magnetic disks, and memory cards. Software and data used to practice embodiments of the present invention, e.g., program 150, can be stored on such portable computer readable storage media and can be loaded onto persistent storage 305 via I/O interface(s) 306. I/O interface(s) 306 also connect to a display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, conventional procedural programming languages, such as the “C” programming language or similar programming languages, and quantum programming languages such as the “Q” programming language, Q#, quantum computation language (QCL) or similar programming languages, low-level programming languages, such as the assembly language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
classifying, by one or more computer processors, each log line in a plurality of unlabeled log lines as an erroneous log line or a non-erroneous log line utilizing a dictionary based classifier within a hybrid error classifier;
templatizing, by one or more computer processors, each classified erroneous log line and non-erroneous log line in the plurality of unlabeled log lines;
clustering, by one or more computer processors, erroneous log templates into erroneous log template clusters and non-erroneous log templates into non-erroneous log template clusters;
identifying, by one or more computer processors, one or more log lines as anomalous utilizing a plurality of factors including a log maturity, a number of encountered log template clusters, and a ratio of classified erroneous log lines to classified non-erroneous log lines;
responsive to one or more identified anomalous log lines, validating, by one or more computer processors, the identified anomalous log lines utilizing a site reliability engineer and human-in-the-loop validation;
training, by one or more computer processors, a log anomaly model within the hybrid error classifier utilizing one or more validated log lines; and
identifying, by one or more computer processors, a subsequent log line as anomalous utilizing the trained log anomaly model.

2. The computer-implemented method of claim 1, wherein identifying the subsequent log line as anomalous utilizing the trained log anomaly model, comprises:
templatizing, by one or more computer processors, the subsequent log line; and
matching, by one or more computer processors, the templatized subsequent log line into an existing erroneous log template cluster or an existing non-erroneous log template cluster.

3. The computer-implemented method of claim 2, further comprising:
responsive to the subsequent log line failing to match into one or more erroneous log template clusters, classifying, by one or more computer processors, the subsequent log line as anomalous;
creating, by one or more computer processors, a new erroneous log template cluster with the subsequent log line;
setting, by one or more computer processors, a frequency of the created erroneous log template cluster to one; and
classifying, by one or more computer processors, an occurrence of similar log lines as anomalous until a frequency threshold is reached or exceeded.

4. The computer-implemented method of claim 2, further comprising:
responsive to the subsequent log line failing to match into one or more non-erroneous log template clusters, classifying, by one or more computer processors, the subsequent log line as non-anomalous;
creating, by one or more computer processors, a new erroneous log template cluster with the subsequent log line;
setting, by one or more computer processors, a frequency of the created erroneous log template cluster to one; and
classifying, by one or more computer processors, an occurrence of similar log lines as non-anomalous until the frequency threshold and a timestamp threshold is reached or exceeded.

5. The computer-implemented method of claim 1, further comprising:
implementing, by one or more computer processors, a remedy to the identified anomalous subsequent log line.

6. The computer-implemented method of claim 1, wherein the dictionary based classifier is bootstrapped utilizing a plurality of invariants and parameters identified in associated product and software documentation.

7. The computer-implemented method of claim 1, wherein the trained log anomaly model is a neural network.

8. A computer program product comprising:
one or more computer readable storage media and program instructions stored on the one or more computer readable storage media, the stored program instructions comprising:
program instructions to classify each log line in a plurality of unlabeled log lines as an erroneous log line or a non-erroneous log line utilizing a dictionary based classifier within a hybrid error classifier;
program instructions to templatize each classified erroneous log line and non-erroneous log line in the plurality of unlabeled log lines;
program instructions to cluster erroneous log templates into erroneous log template clusters and non-erroneous log templates into non-erroneous log template clusters;
program instructions to identify one or more log lines as anomalous utilizing a plurality of factors including a log maturity, a number of encountered log template clusters, and a ratio of classified erroneous log lines to classified non-erroneous log lines;
program instructions to responsive to one or more identified anomalous log lines, validate the identified anomalous log lines utilizing a site reliability engineer and human-in-the-loop validation;
program instructions to train a log anomaly model within the hybrid error classifier utilizing one or more validated log lines; and
program instructions to identify a subsequent log line as anomalous utilizing the trained log anomaly model.

9. The computer program product of claim 8, wherein the program instructions, to identify the subsequent log line as anomalous utilizing the trained log anomaly model, comprise:
program instructions to templatize the subsequent log line; and
program instructions to match the templatized subsequent log line into an existing erroneous log template cluster or an existing non-erroneous log template cluster.

10. The computer program product of claim 9, wherein the program instructions, stored on the one or more computer readable storage media, further comprise:
program instructions to responsive to the subsequent log line failing to match into one or more erroneous log template clusters, classify the subsequent log line as anomalous;
program instructions to create a new erroneous log template cluster with the subsequent log line;
program instructions to set a frequency of the created erroneous log template cluster to one; and
program instructions to classify an occurrence of similar log lines as anomalous until a frequency threshold is reached or exceeded.

11. The computer program product of claim 9, wherein the program instructions, stored on the one or more computer readable storage media, further comprise:
program instructions to responsive to the subsequent log line failing to match into one or more non-erroneous log template clusters, classify the subsequent log line as non-anomalous;
program instructions to create a new erroneous log template cluster with the subsequent log line;
program instructions to set a frequency of the created erroneous log template cluster to one; and
program instructions to classify an occurrence of similar log lines as non-anomalous until the frequency threshold and a timestamp threshold is reached or exceeded.

12. The computer program product of claim 8, wherein the program instructions, stored on the one or more computer readable storage media, further comprise:
program instructions to implement a remedy to the identified anomalous subsequent log line.

13. The computer program product of claim 8, wherein the dictionary based classifier is bootstrapped utilizing a plurality of invariants and parameters identified in associated product and software documentation.

14. The computer program product of claim 8, wherein the trained log anomaly model is a neural network.

15. A computer system comprising:
one or more computer processors;
one or more computer readable storage media; and
program instructions stored on the computer readable storage media for execution by at least one of the one or more processors, the stored program instructions comprising:
program instructions to classify each log line in a plurality of unlabeled log lines as an erroneous log line or a non-erroneous log line utilizing a dictionary based classifier within a hybrid error classifier;
program instructions to templatize each classified erroneous log line and non-erroneous log line in the plurality of unlabeled log lines;
program instructions to cluster erroneous log templates into erroneous log template clusters and non-erroneous log templates into non-erroneous log template clusters;
program instructions to identify one or more log lines as anomalous utilizing a plurality of factors including a log maturity, a number of encountered log template clusters, and a ratio of classified erroneous log lines to classified non-erroneous log lines;
program instructions to responsive to one or more identified anomalous log lines, validate the identified anomalous log lines utilizing a site reliability engineer and human-in-the-loop validation;
program instructions to train a log anomaly model within the hybrid error classifier utilizing one or more validated log lines; and
program instructions to identify a subsequent log line as anomalous utilizing the trained log anomaly model.

16. The computer system of claim 15, wherein the program instructions, to identify the subsequent log line as anomalous utilizing the trained log anomaly model, comprise:
program instructions to templatize the subsequent log line; and
program instructions to match the templatized subsequent log line into an existing erroneous log template cluster or an existing non-erroneous log template cluster.

17. The computer system of claim 16, wherein the program instructions, stored on the one or more computer readable storage media, further comprise:
program instructions to responsive to the subsequent log line failing to match into one or more erroneous log template clusters, classify the subsequent log line as anomalous;
program instructions to create a new erroneous log template cluster with the subsequent log line;
program instructions to set a frequency of the created erroneous log template cluster to one; and
program instructions to classify an occurrence of similar log lines as anomalous until a frequency threshold is reached or exceeded.

18. The computer system of claim 16, wherein the program instructions, stored on the one or more computer readable storage media, further comprise:
program instructions to responsive to the subsequent log line failing to match into one or more non-erroneous log template clusters, classify the subsequent log line as non-anomalous;
program instructions to create a new erroneous log template cluster with the subsequent log line;
program instructions to set a frequency of the created erroneous log template cluster to one; and
program instructions to classify an occurrence of similar log lines as non-anomalous until the frequency threshold and a timestamp threshold is reached or exceeded.

19. The computer system of claim 15, wherein the program instructions, stored on the one or more computer readable storage media, further comprise:
program instructions to implement a remedy to the identified anomalous subsequent log line.

20. The computer system of claim 15, wherein the dictionary based classifier is bootstrapped utilizing a plurality of invariants and parameters identified in associated product and software documentation.
